(19) United States
(12) Patent Application Publication
(10) Pub. No.: US 2013/0080226 A1
(43) Pub. Date: Mar. 28, 2013

(54) SYSTEM AND METHOD FOR PROVIDING REWARDS AND ONLINE ADVERTISING IN AN ONLINE SOCIAL ENVIRONMENT

(71) Applicant: Christopher Keith, New York, NY (US)

(72) Inventor: Christopher Keith, New York, NY (US)

(73) Assignee: Christopher Keith, New York, NY (US)

(21) Appl. No.: 13/245,433

(22) Filed: Sep. 26, 2011

(51) Int. Cl. G06Q 30/02; G06Q 30/06

(52) U.S. Cl. 705/14.23; 705/14.49

(57) ABSTRACT

Embodiments of the invention are directed to creating an online social environment that allows users to obtain, own, and use one or more tokens whose value is derived from their presence within an online social environment. A user is given a single deal reward token based on the mapping of that token to a deal reward provided to a user. A user must own at least one deal reward tokens linked to a primary prize in order to obtain that prize. A user owning at least one deal reward token linked to a primary prize is given that prize. A user is proved a system for conducting transactions with other users related to their owned deal reward tokens. A single advertising source is associated with each of a user's deal reward tokens. An advertising source is provided the online technical means of sending continuous targeted advertisement material to the user associated with each deal reward token linked to that advertising source. A user is provided a system for displaying the continuous targeted advertisement material provided by the advertising source associated with that user's deal reward token.

### FIELD OF ART

The invention generally relates to online commerce. More particularly, the invention relates to systems and methods for providing rewards and online advertising in an online marketplace.

### PRIOR ART

The following is a list of some prior art that presently appears relevant:

| Patent Number | Issue Date | Patentee |
|---|---|---|
| 7,976,376 | 2011 | Kroeckel et al. |
| 7,976,373 | 2011 | Kroeckel et al. |
| 7,962,374 | 2011 | Altschuler |
| 7,958,224 | 2011 | Amjadi |
| 7,895,073 | 2011 | Antonello et al. |
| 7,865,393 | 2011 | Leason et al. |
| 7,861,176 | 2010 | Weisberg |
| 7,828,206 | 2011 | Hessburg et al. |
| 7,797,168 | 2010 | Kusumoto et al. |
| 7,788,134 | 2010 | Manber et al. |
| 7,788,129 | 2010 | Antonucci et al. |
| 7,599,850 | 2009 | Laor |
| 7,401,032 | 2008 | Golden et al. |
| 6,978,253 | 2005 | Lin |
| 6,632,142 | 2003 | Keith |

| Publication Number | Publ. Date | Applicant |
|---|---|---|
| 20110218852 | 2011 | Zhang et al. |
| 20110208595 | 2011 | Besmertnik et al. |
| 20110125569 | 2011 | Yoshimura et al. |
| 20110119125 | 2011 | Javangula et al. |
| 20110124392 | 2011 | Kroeckel et al. |
| 20110117997 | 2011 | Kroeckel et al. |
| 20110086712 | 2011 | Cargill |
| 20110077069 | 2011 | Kroeckel et al. |
| 20110053692 | 2011 | Farr-Jones et al. |
| 20110035265 | 2011 | King et al. |
| 20110035264 | 2011 | Zaloom |
| 20110029363 | 2011 | Gillenson et al. |
| 20110015955 | 2011 | Hessburg et al. |
| 20110010245 | 2011 | Priebatsch et al. |
| 20100318407 | 2011 | Leff et al. |
| 20100293569 | 2010 | Kusumoto et al. |
| 20100174601 | 2010 | Yu |
| 20100077017 | 2010 | Martinez et al. |
| 20080167130 | 2008 | Kroeckel et al. |
| 20080167118 | 2008 | Kroeckel et al. |

### BACKGROUND

Many online rewards systems and methods exist today that offer online users a chance to win prizes and other rewards if they complete tasks such as answering surveys or providing their personal information. These systems typically offer a user a reward for completing a task, track when a user does the task, rewards the user for doing the task, and then sells the user's online presence and task-related data to advertisers and other interested parties.

While these systems and methods have proven effective, users are increasingly wary of providing their personal information for a small reward, and have become adept at “gaming” these systems to maximize their rewards while minimizing the attentive activity needed to perform the necessary tasks. Furthermore, advertisers have become reluctant to place a high value on information generated from these simple online rewards programs because they are aware of the limited attention most users pay to the tasks needed to achieve the rewards. In addition, many advertisers believe that the current systems and methods for associating users with completed tasks does not generate sufficiently detailed data to allow highly targeted advertisements to users in a manner that would allow extended advertising viewership by users. Finally, many users accustomed to receiving or winning rewards online choose not to sell or use them immediately, but instead chose to keep these rewards as collectibles for some period of time. It is with respect to these considerations and others that the present invention is directed.

### SUMMARY OF THE INVENTION

Embodiments of the present invention comprise a system and method for creating an online social environment that allows users to obtain, own, and use one or more tokens whose value is derived from their presence within an online social environment. In one embodiment, online users obtain a deal reward from a merchant. A deal reward token is provided to the user based on that user receiving a deal reward. That token is one of a larger set of tokens. In one embodiment, that token is one of 12 animal icons (bear, monkey, tiger, etc.) in 5 colors (red, green, blue, red, and yellow), resulting in a total of 60 unique token types such as red bear, green monkey, or yellow tiger. By owning all five colors of one animal icon (red bear, green bear, etc.), a user is eligible to win a prize. In one embodiment, the first user to obtain the five tokens representing an animal icon in each color would win the prize associated with such a token combination. Similarly, the first user or group of users to collect multiple combinations of select tokens could win additional or more substantial prizes.

In one embodiment, each token also represents a specific advertising source who provides the user with continuous targeted advertisement materials based on that user's perceived interest in receiving such material based on their obtaining the associated reward token. In one embodiment, the continuous advertisement materials could be a coupon for the user in a focused interest area such as golf or kitchenware. In one embodiment, the advertising source is provided the online technical means to impact the sending of the advertisement material. In one embodiment, the user is provided the online technical means to impact the viewing of the advertisement material.

These exemplary embodiments are mentioned not to limit or define the invention, but to provide examples of embodiments of the invention to aid understanding thereof. Exemplary embodiments are discussed in the detailed description and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following detailed description is read with reference to the accompanying drawings, wherein:

FIG. 1 is a schematic illustrating an exemplary environment in which one embodiment of the present invention may operate;

FIG. 2A illustrates a flow diagram of a method for providing prizes to a user in accordance with one embodiment of the present invention;

FIG. 2B illustrates a flow diagram of a method for providing prizes and a deal reward to a user in accordance with one embodiment of the present invention;

FIG. 2C illustrates a flow diagram of a method for providing prizes and collecting attribute data of an identified user at an online location using an online identification instrument in accordance with one embodiment of the present invention;

FIG. 2D illustrates a flow diagram of a method for providing prizes, collecting attribute data of an identified user at an online location using an online identification instrument, and using preferences filter in accordance with one embodiment of the present invention;

FIG. 2E illustrates a flow diagram of a method for providing prizes, collecting attribute data of an identified user at an online location using an online identification instrument, using a preferences filter in accordance with one embodiment of the present invention, and providing a deal reward to a user based on a user's collected attribute data in accordance with one embodiment of the present invention;

FIG. 3A illustrates a flow diagram of a method for providing a user with continuous targeted advertisement materials based on a single advertising source in accordance with one embodiment of the present invention;

FIG. 3B illustrates a flow diagram of a method for providing a user with continuous targeted advertisement materials based on more than one advertising source in accordance with one embodiment of the present invention;

FIG. 3C illustrates a flow diagram of a method for providing a user with an online technical means of communicating electronically with the advertising source and providing the user with continuous targeted advertisement materials based on a single advertising source in accordance with one embodiment of the present invention;

FIG. 3D illustrates a flow diagram of a method for providing a user with an online technical means of altering the displaying of continuous targeted advertisement material by an advertising source based on a preferences filter and providing the user with continuous targeted advertisement materials based on a single advertising source in accordance with one embodiment of the present invention;

FIG. 3E illustrates a flow diagram of a method for providing a user with an online technical means of altering the viewing of continuous targeted advertisement material based on a preferences filter and providing the user with continuous targeted advertisement materials based on a single advertising source in accordance with one embodiment of the present invention;

### DETAILED DESCRIPTION OF EMBODIMENTS

The present invention provides a system and methods for providing an online environment to users that enables the users to obtain one or more tokens that may have value within the online environment and providing the users and advertising sources with access to targeted continuous advertising channels associated with a token.

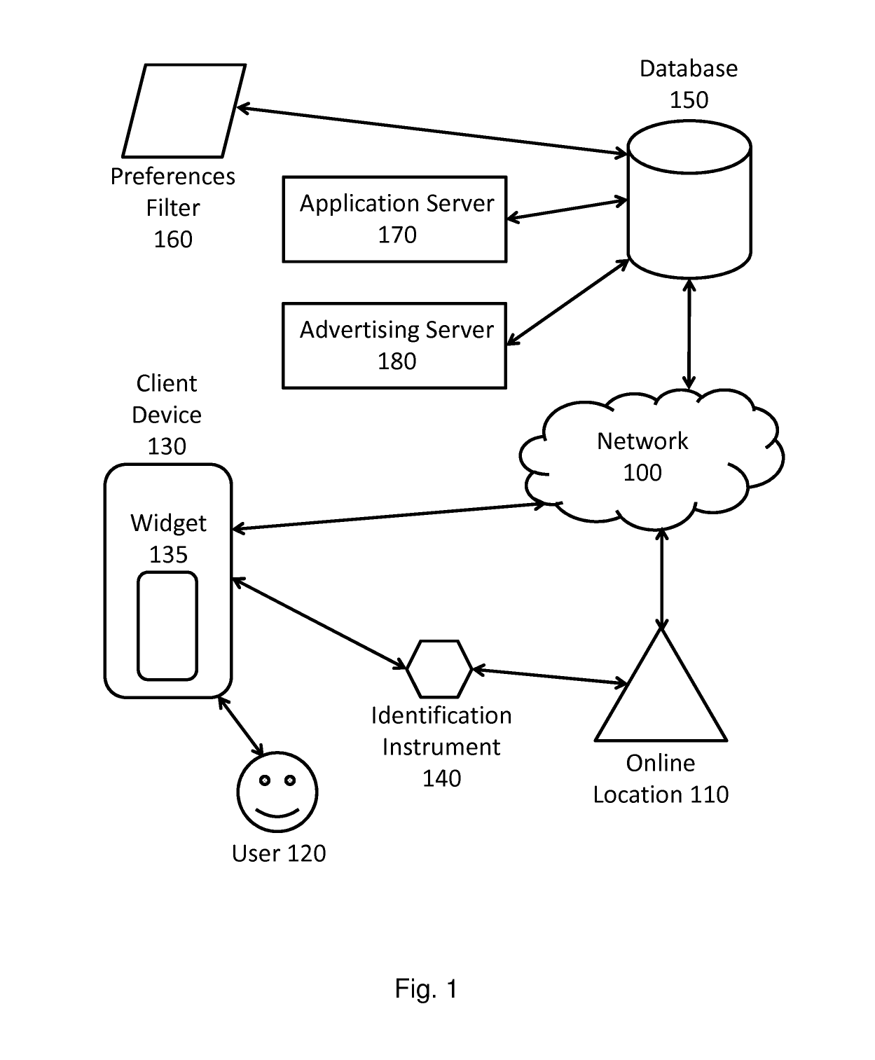

FIG. 1 is a schematic illustrating an exemplary logical computing environment in which one embodiment of the present invention may operate. Network 100 provides online access to the other elements of the environment. The online access may be wired or wireless, and may connect to the Internet or some other type of online network. A network may be part of a larger network that provides online access to the elements of the environment. The online environment may be used as an online marketplace.

Online location 110 may be a website accessed through the Internet, an intranet location, an online computer, an online software program, or some other online access mechanism. User 120 can access the online location 110 using their client device 130 that is connected to network 100. User 120 can be a person or a computer program. Client device 130 can be a computer, a mobile phone, a handheld tablet device, or any other client device capable of accessing online location 110 through network 100. Widget 135 can be a software application of or hardware device attached to client device 130. Widget 135 provides a means for user 120, network 100, identification instrument 140, database 150, application server 170, advertising server 180, and preferences filter 180 to communicate and perform their respective functions in the exemplary logical computing environment.

Identification instrument 140 provides identifying data about user 120 and client device 130. Identification instrument 140 can be a traditional cookie, web beacon, Application Programming Interface (API) or other means of providing data about user 120 to network 100, online location 110, database 150, and preferences filter 160. In one embodiment shown here, identification instrument 140 is independent of either the client device 130 or online location 110. In another embodiment, client device 130 includes an identification instrument 140. In a third embodiment, identification instrument is served by online location 110. Database 150 indexes collected user data that can be obtained from identification instrument 140, online location 110, or network 100.

In one embodiment, database 150 would obtain data from client device 130 that for a given period of time, was used by three separate people who visited two separate locations. Each user therefore provided separate data to one or more identification instruments as well as to each online location they visited. In this particular embodiment, each separate user's data could be stored in three separate databases. Thus, database 150 would index all of the relevant data for future usage as shown in the illustrative table below. To clarify, user 120, user 120′, and user 120″ all used Client 120 to access their chosen online location. Data about them and their online activities related to the online location and other relevant network elements such as network 100 are each stored in a separate database for this particular embodiment. On other embodiments, a single database could be used. This is not a requirement, merely one embodiment of the present invention. Thus, User 120's data is stored in Database 150 while the data related to user 120′ is stored in Database 150′. Note that the “n . . . ” column and “n . . . ” row represent the fact that the online data catalog 150's structure is not inherently limited in the amount of data or the format in which data is stored.

| | | Online Location | Database Used to | |
|---|---|---|---|---|
| User | Client | Visited | Store user Data | n . . . |
| User 120 | Client | Online Location | Database 150 | . . . |
| | Device 130 | 110′ | | |
| User 120′ | Client | Online Location | Database 150′ | . . . |
| | Device 130 | 110 | | |
| User 120″ | Client | Online Location | Database 150″ | . . . |
| | Device 130 | 110″ | | |
| n . . . | . . . | . . . | . . . | . . . |

The preferences filter 160 contains data about the contact preferences of the user 120. This filter is used to help ensure that the data queries executed conform to the user preferences listed in the preferences filter. In one embodiment, if a user 120 had previously indicated through their client device 130, identification instrument 140, or through their interaction with online location 110 that they did not want their presence in online location 110 to be stored by database 150, that preference would be stored in preferences filter 160 and acted upon by database 150.

The application server 170 contains information that may include information about the online social environment, users, deal reward tokens, primary and secondary prizes, payment mechanisms, and other information necessary to provide a prize to a user based on that user's ownership of a specified collection of deal reward tokens. In one embodiment, a user 120 using their client device 130 activates a widget 135 that prompts identification instrument 140 to identify him to an online location 140 using network 100. This identification then prompts application server 170 to use preferences filter 160 to determine that user 120 is expecting advertising server 180 to send advertising information to user 120 after recording that advertising information in database 150.

The advertising server 180 provides advertising information that may include information about an advertising source, online advertising channels, advertising networks, targeted advertisement material, a user's advertisement preferences, deal reward tokens, and any other information that may be necessary to provide a persistent link between an advertising source and a user in order to provide a continuous online advertising channel. In one embodiment, a user 120 using their client device 130 activates a widget 135 that prompts identification instrument 140 to identify him to an online location 140 using network 100. This identification then prompts application server 170 to use preferences filter 160 to determine that user 120 is expecting advertising server 180 to send advertising information to user 120 after recording that advertising information in database 150. Advertising server 180 then confirms the advertising source associated with a deal reward token belonging to user 120 and provides targeted advertisement material to user 120.

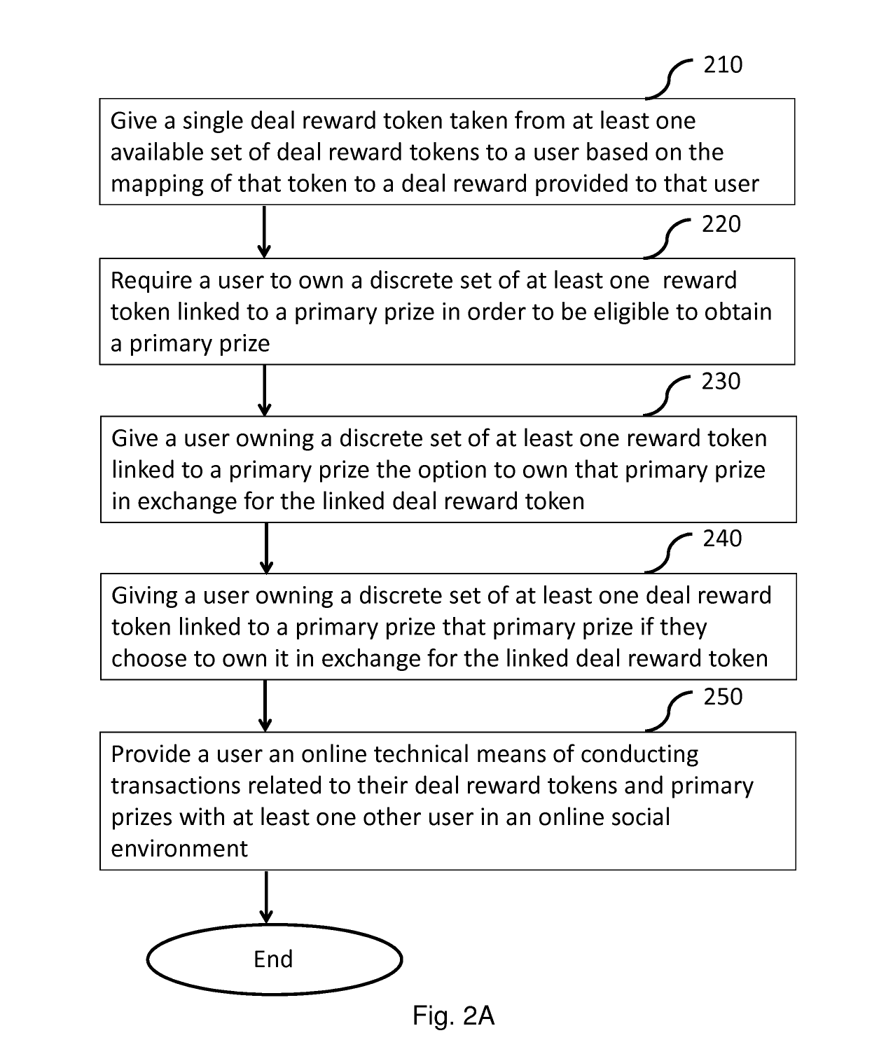

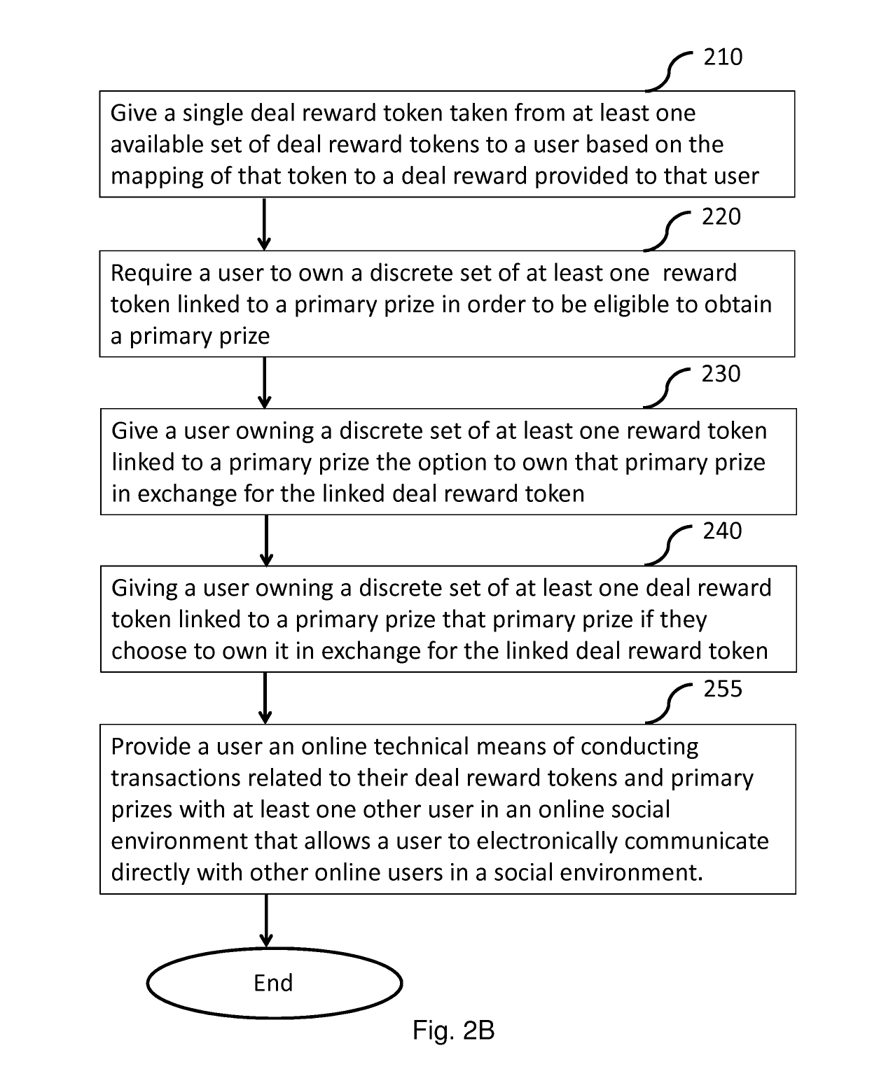

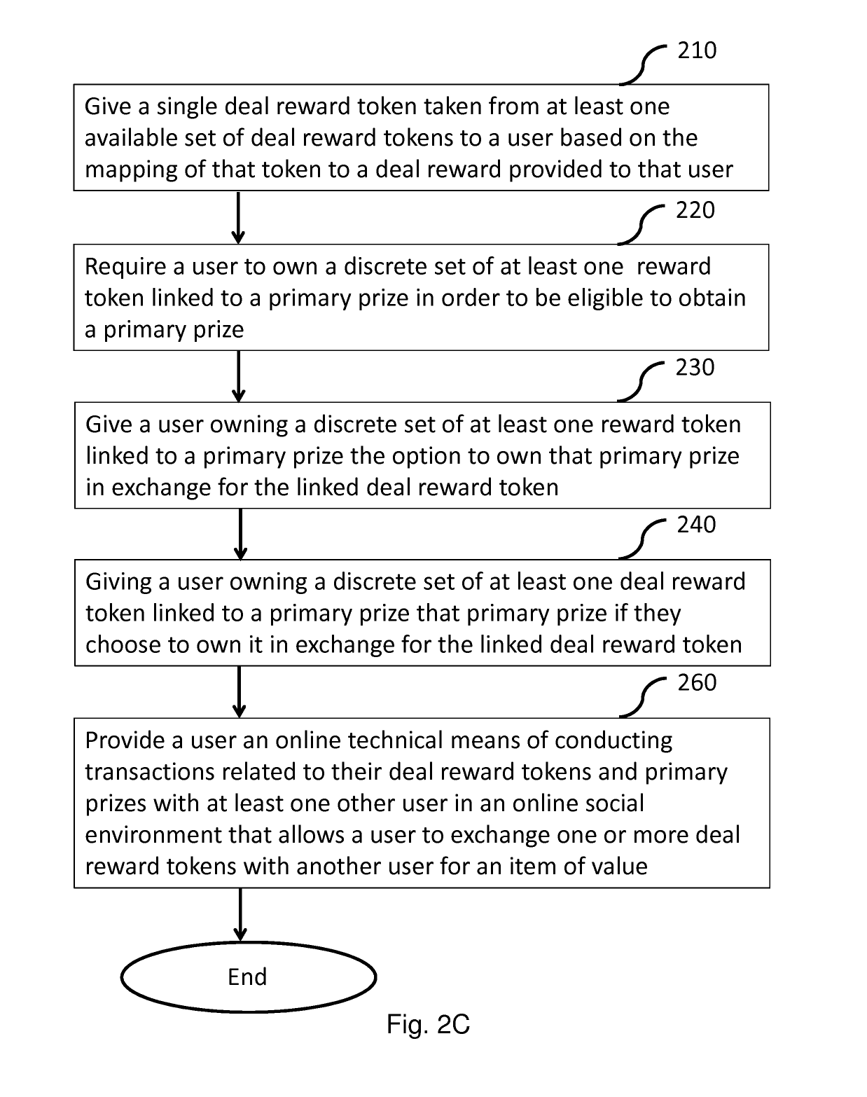

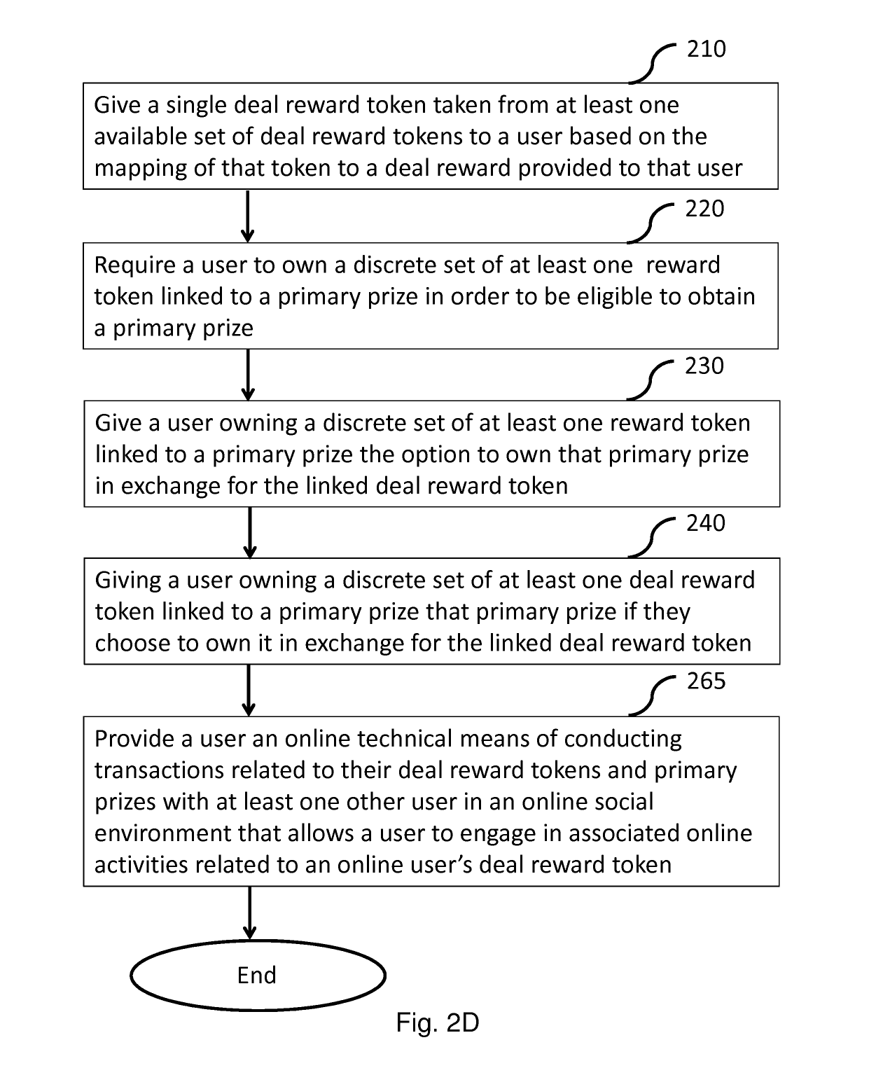

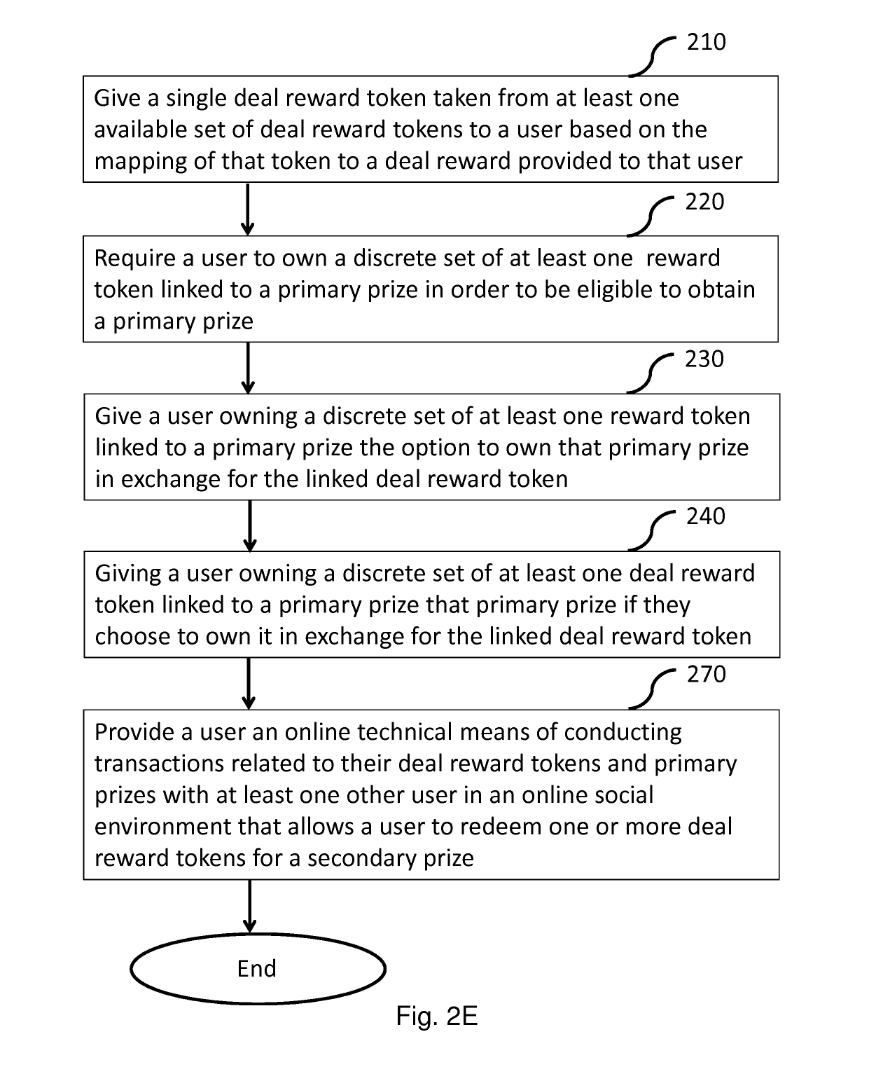

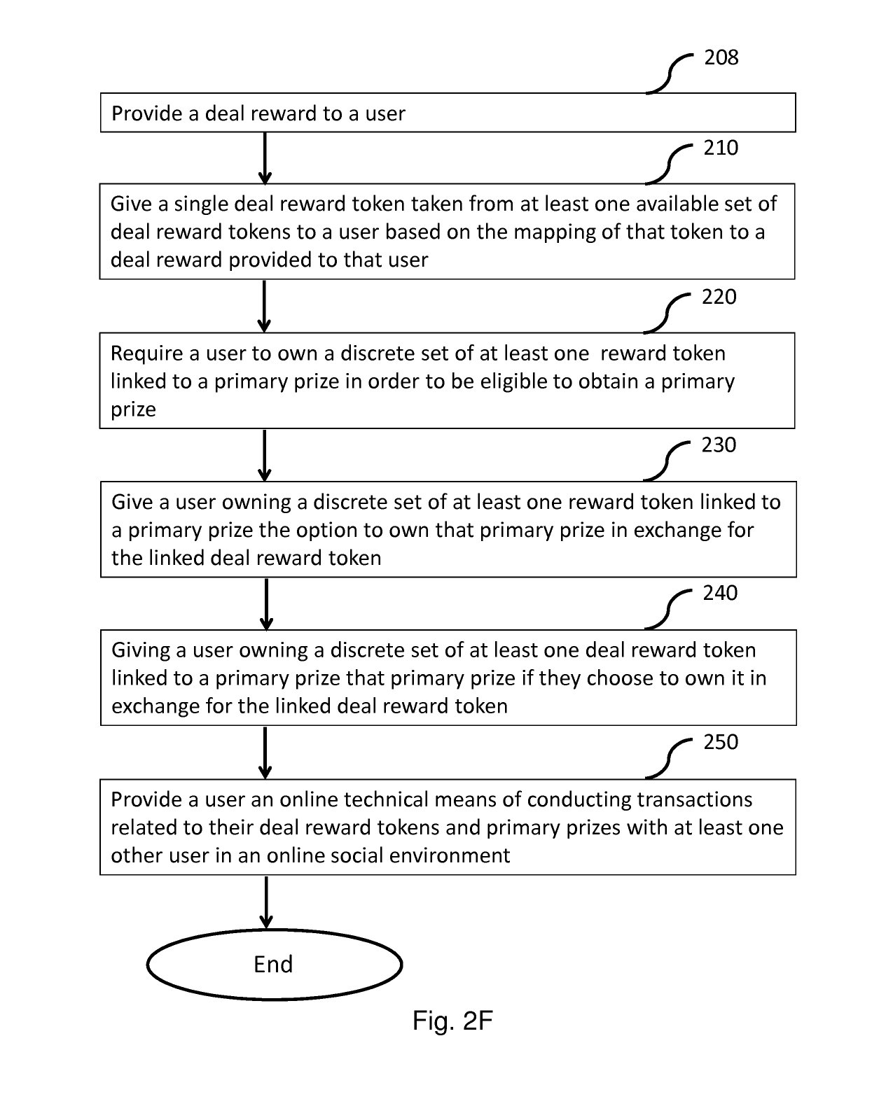

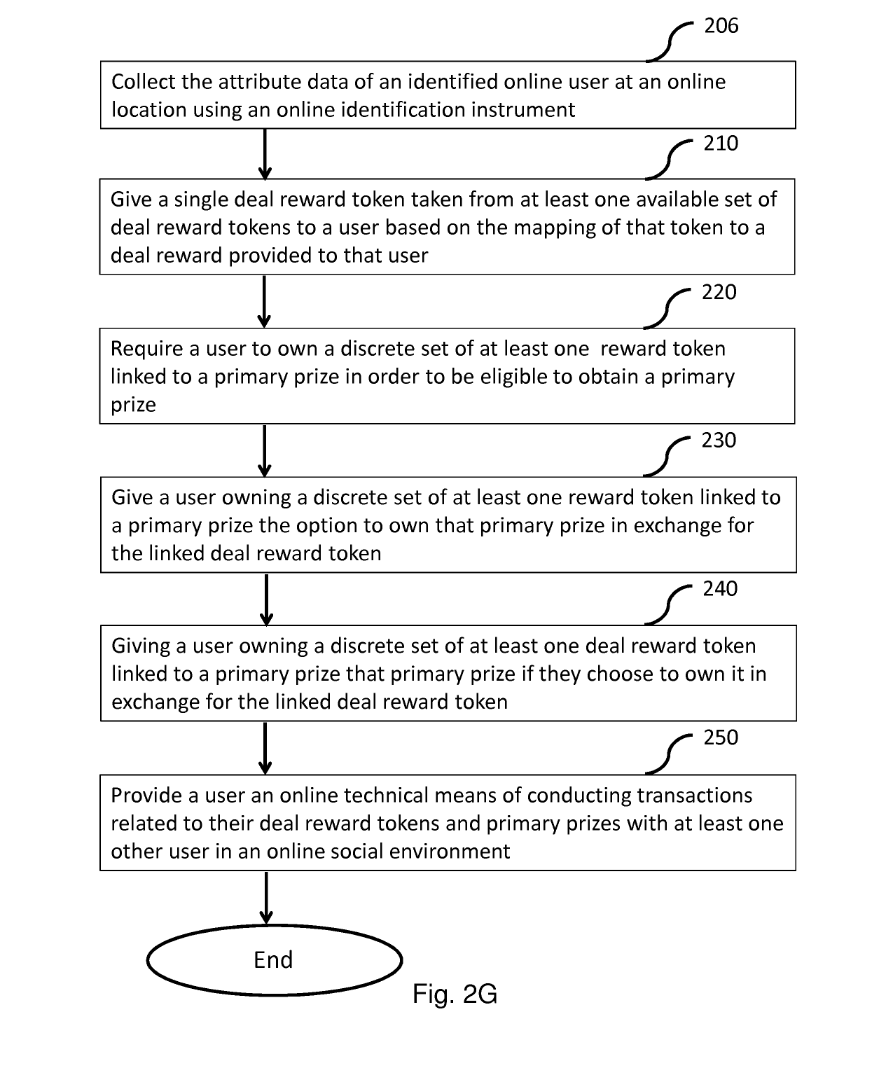

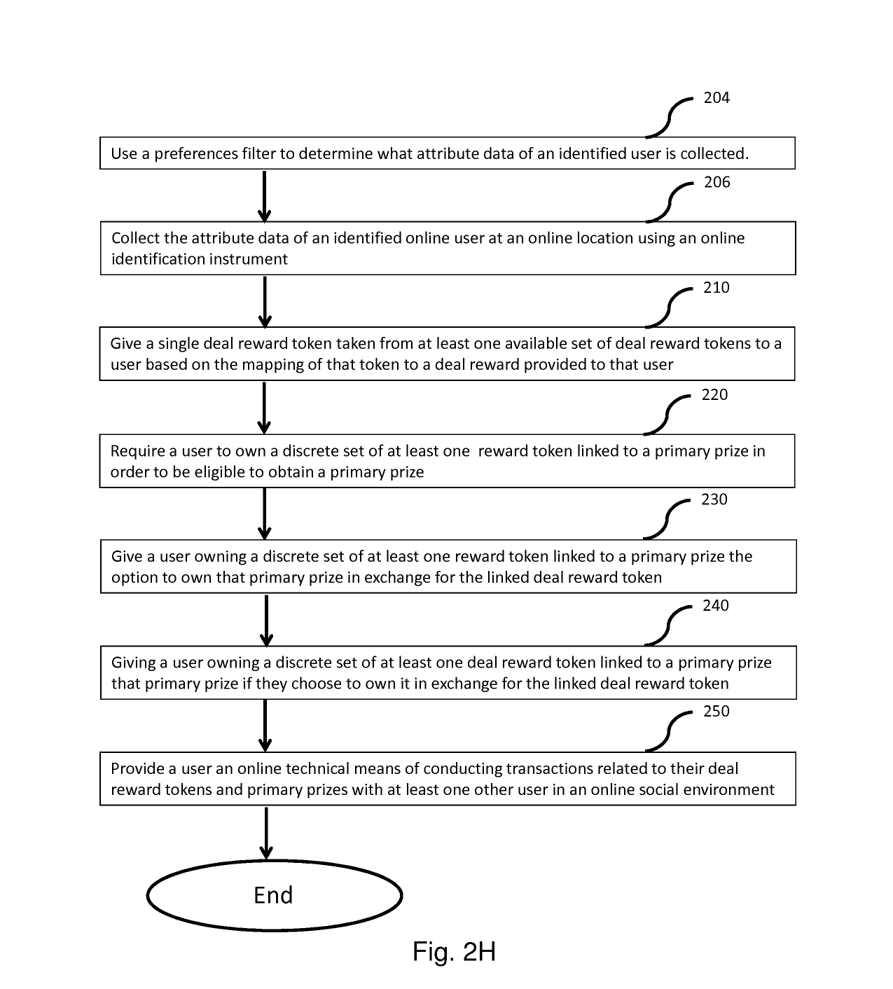

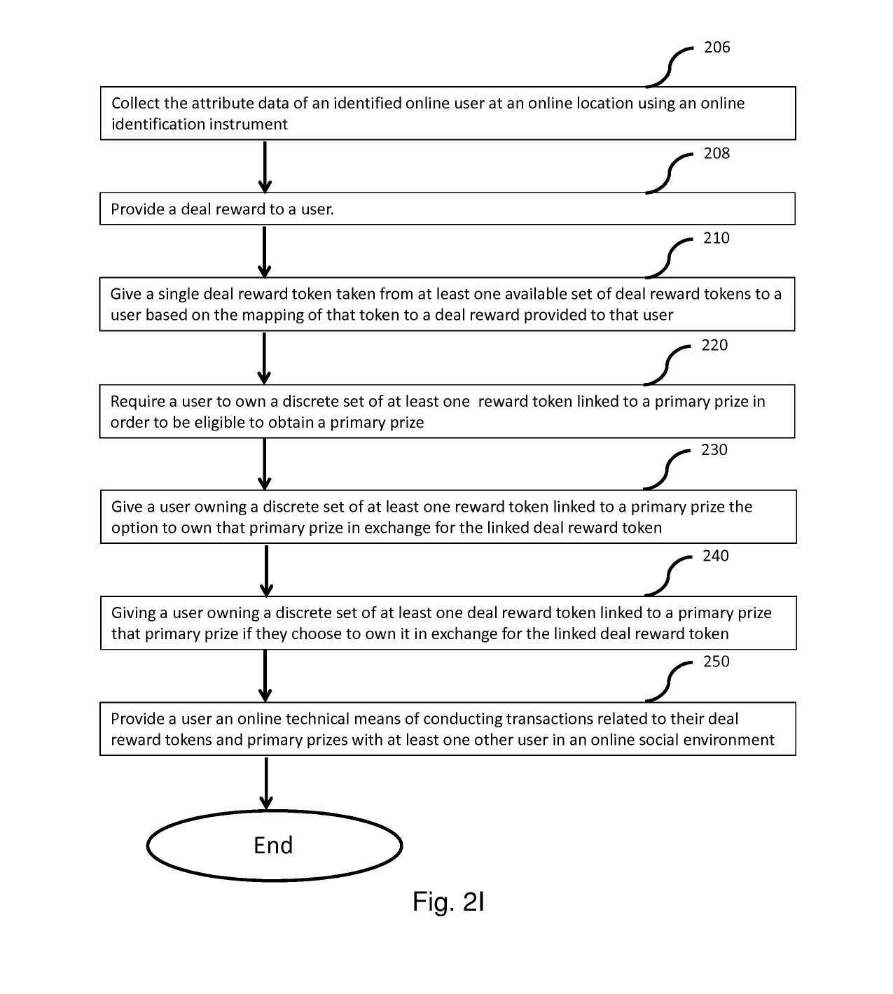

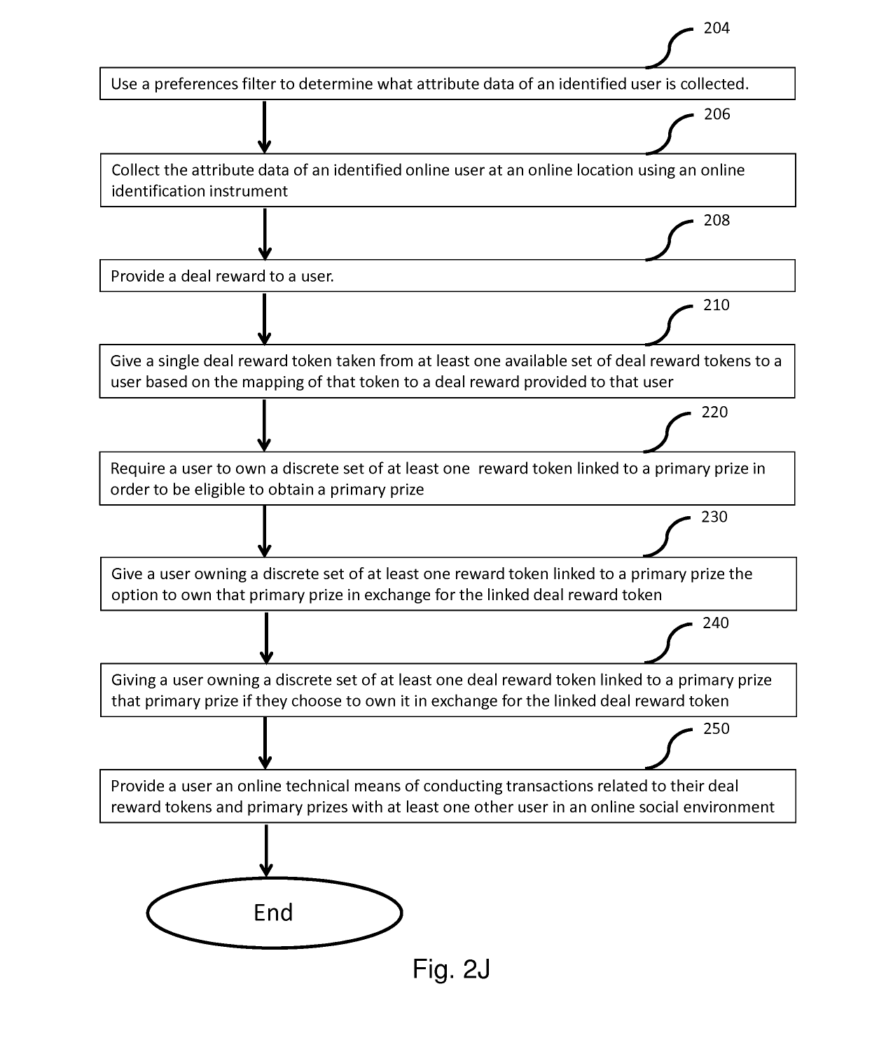

FIGS. 2A, 2B, 2C, 2D, 2E, 2F, 2G, 2H, 2I, and 2J are flow diagrams illustrating different scenarios in which a process is used for providing prizes. It should be noted that any process descriptions or blocks in flow diagrams should be understood as representing steps for implementing specific logical functions in the process. Furthermore, alternative implementations are included within the scope of the present invention in which functions may be executed out of order from that shown or discussed, including substantially concurrently or in reverse order, depending on the functionality involved, as would be understood by those reasonably skilled in the art of the present invention.

As shown in FIG. 2A, a user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 250, a user is provided access to a system for conducting transactions with at least one user in an online social environment related to that user's owned deal reward tokens and primary prizes. In one embodiment, a user is given a single deal reward token from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users.

As shown in FIG. 2B, a user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 255, a user is provided access to a system for conducting transactions with at least one user in an online social environment related to that user's owned deal reward tokens and primary prizes that allows a user to electronically communicate directly with other online users in a social environment. In one embodiment, a user is given a single deal reward token from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users in block 255 to communicate with another user in the online social environment about potential trading options for his blue fox token.

As shown in FIG. 2C, a user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 260, a user is provided access to a system for conducting transactions with at least one user in an online social environment related to that user's owned deal reward tokens and primary prizes that allows a user to exchange one or more deal reward tokens with another user for an item of value. In one embodiment, a user is given a single deal reward token from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users. He then exchanges his blue fox token for another user's token that is part of a separate and larger set of tokens linked to a $500 gift certificate to a clothing store.

As shown in FIG. 2D, a user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 265, a user is provided access to a system for conducting transactions with at least one user in an online social environment related to that user's owned deal reward tokens and primary prizes that allows a user to engage in associated online activities related to an online user's deal reward token. In one embodiment, a user is given a single deal reward token from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system and plan an online game related to the blue fox token.

As shown in FIG. 2E, a user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 270, a user is provided access to a system for conducting transactions with at least one user in an online social environment related to that user's owned deal reward tokens and primary prizes that allows a user to redeem one or more deal reward tokens for a secondary prize. In one embodiment, a user is given a single deal reward token from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to claim a secondary prize of a $50 cash prize.

As shown in FIG. 2F, a deal reward is provided to the user in block 208. A user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 250, a user is provided access to a system for conducting transactions with at least one user in an online social environment related to that user's owned deal reward tokens and primary prizes. In one embodiment, a user is given a deal reward after buying a movie ticket by a merchant interested in using the deal reward system to promote his movie theatre. Associated with that purchase is a deal reward token that the merchant gives to the user. This token is from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users.

As shown in FIG. 2G, attribute data of a user at an online location is collected using an online identification instrument in block 206. A user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 250, a user is provided access to a system for conducting transactions with at least one user in an online social environment related to that user's owned deal reward tokens and primary prizes. In one embodiment, a cookie collects attribute data of a user at an electronics website including a user's Internet Protocol (IP) address, last five frequented websites, and the type of Internet browser he is using. A user is then given a deal reward token. This token is from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users.

As shown in FIG. 2H, a preferences filter is used to determine what attribute data of an identified user is collected in block 204. Attribute data of a user at an online location is collected using an online identification instrument in block 206. A user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 250, a user is provided access to a system for conducting transactions with at least one user in an online social environment related to that user's owned deal reward tokens and primary prizes. In one embodiment, a preferences filter is used to determine that a user does not want their IP address collected by the system. A cookie that can collect attribute data of a user at an electronics website including a user's IP address, last five frequented websites, and the type of Internet browser they are using collects all of that information except the IP address because the preferences filter indicated a desire of the user to not have their IP address collected. A user is then given a deal reward token. This token is from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users.

As shown in FIG. 2I, attribute data of a user at an online location is collected using an online identification instrument in block 206. A deal reward is provided to the user in block 208 based on the collected attribute data. A user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 250, a user is provided access to a system for conducting transactions with at least one user in an online social environment related to that user's owned deal reward tokens and primary prizes. In one embodiment, a cookie collects attribute data of a user at an electronics website including a user's Internet Protocol (IP) address, last five frequented websites, and the type of Internet browser they are using. A user is given a deal reward after buying a movie ticket by a merchant interested in using the deal reward system to promote his movie theatre based on the collected attribute data that user. Associated with that purchase is a deal reward token that the merchant gives to the user. This token is from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users.

As shown in FIG. 2J, a preferences filter is used to determine what attribute data of an identified user is collected in block 204. Attribute data of a user at an online location is collected using an online identification instrument in block 206. A deal reward is provided to the user in block 208 based on the collected attribute data. A user is given a single deal reward token taken from at least one available set of deal reward tokens based on the mapping of that token to a deal reward provided to that user in block 210. In block 220, a user is required to own a discrete set of at least one deal reward token linked to a primary prize in order to be eligible to obtain a primary prize. In block 230, a user is given a discrete set of at least one deal reward token linked to a primary prize the option to own that primary prize in exchange for the linked deal reward token. In block 240, a user is given the primary prize linked to their owned deal reward token if they choose to own it in exchange for the linked deal reward token. In block 250, a user is provided access to a system for conducting transactions with at least one user in an online social environment related to that user's owned deal reward tokens and primary prizes. In one embodiment, a preferences filter is used to determine that a user does not want their IP address collected by the system. A cookie that can collect attribute data of a user at an electronics website including a user's IP address, last five frequented websites, and the type of Internet browser they are using collects all of that information except the IP address because the preferences filter indicated a desire of the user to not have their IP address collected. A user is given a deal reward after buying a movie ticket by a merchant interested in using the deal reward system to promote his movie theatre based on the collected attribute data that user. Associated with that purchase is a deal reward token that the merchant gives to the user. This token is from two sets of deal reward tokens. One deal token set represents color tokens including blue, red, green, yellow, and black. Another deal token set represents animal tokens including a bear, a fox, a tiger, a wolf, and an eagle. In this embodiment, the user's deal reward token is a blue fox token. This blue fox token is linked to a primary prize that is a $100 gift certificate to an electronics store. Because this token is linked to the primary prize and because the user owns this blue fox token, he is given the option to own the $100 gift certificate in exchange for the blue fox token. In this embodiment, the user chooses not to take ownership of the $100 gift certificate and instead decides to maintain ownership of the token as a collectible and access the system that allows him to conduct transactions with other users.

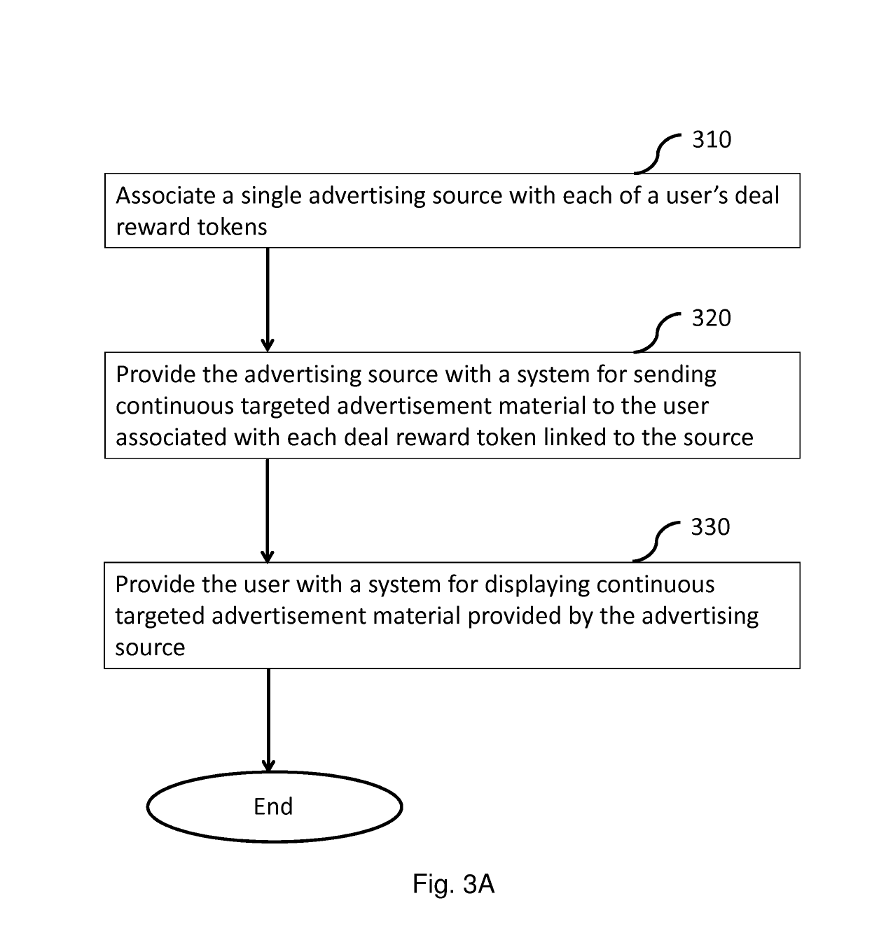

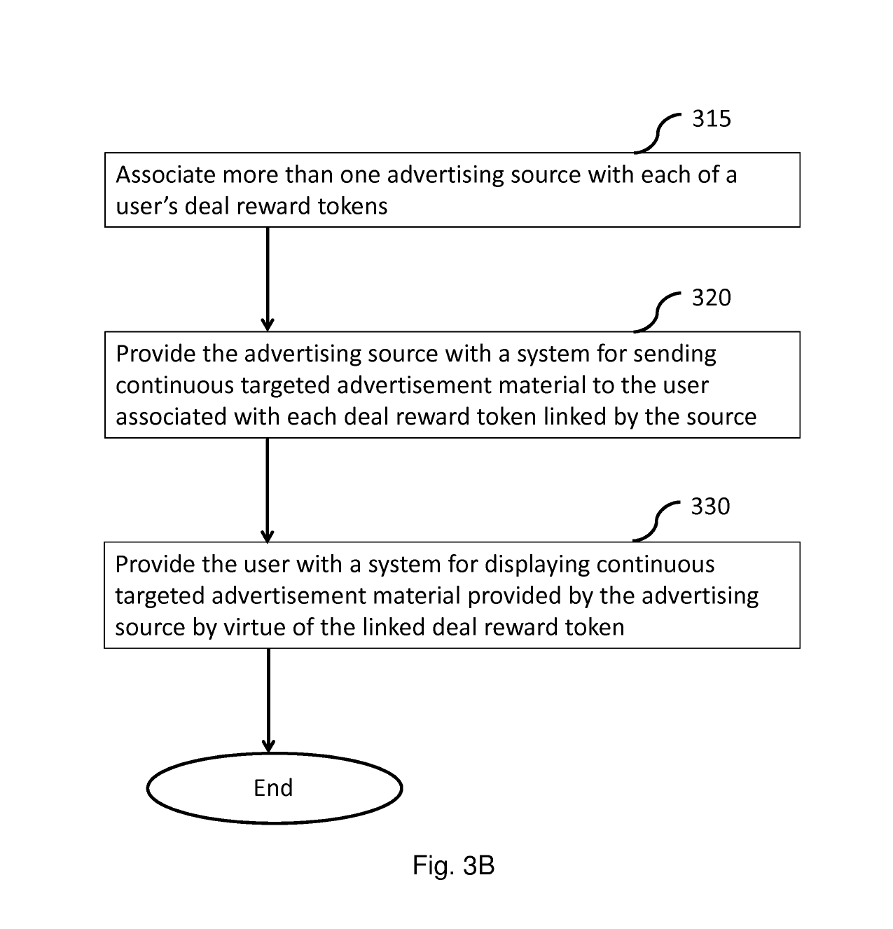

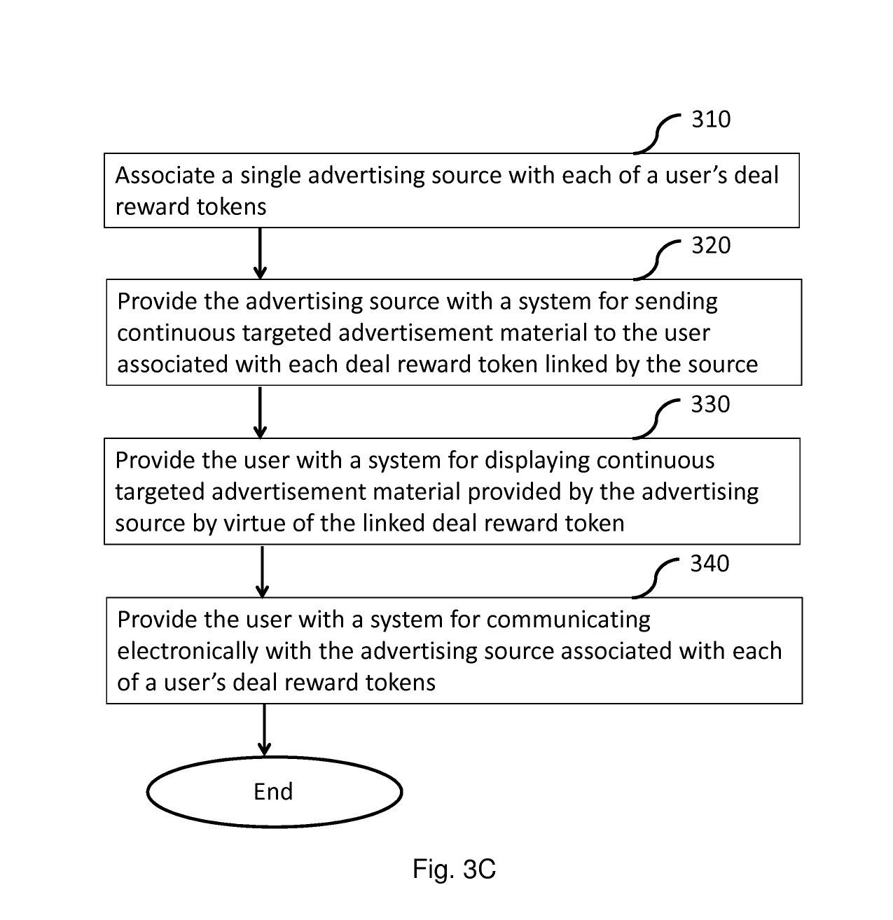

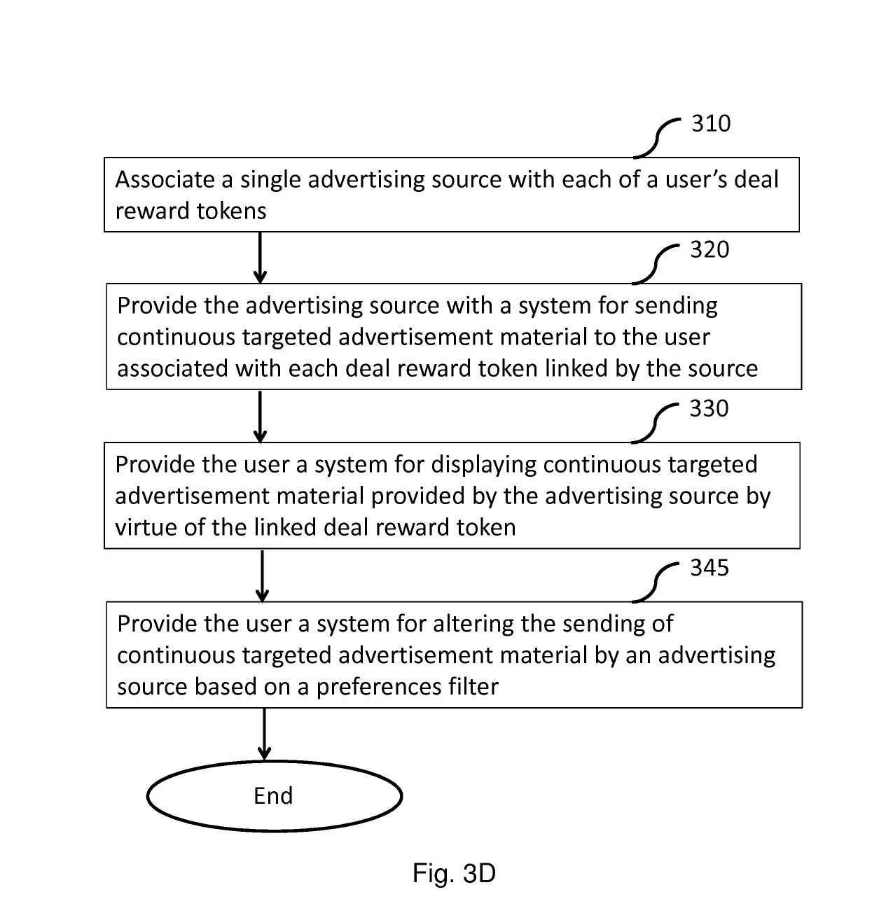

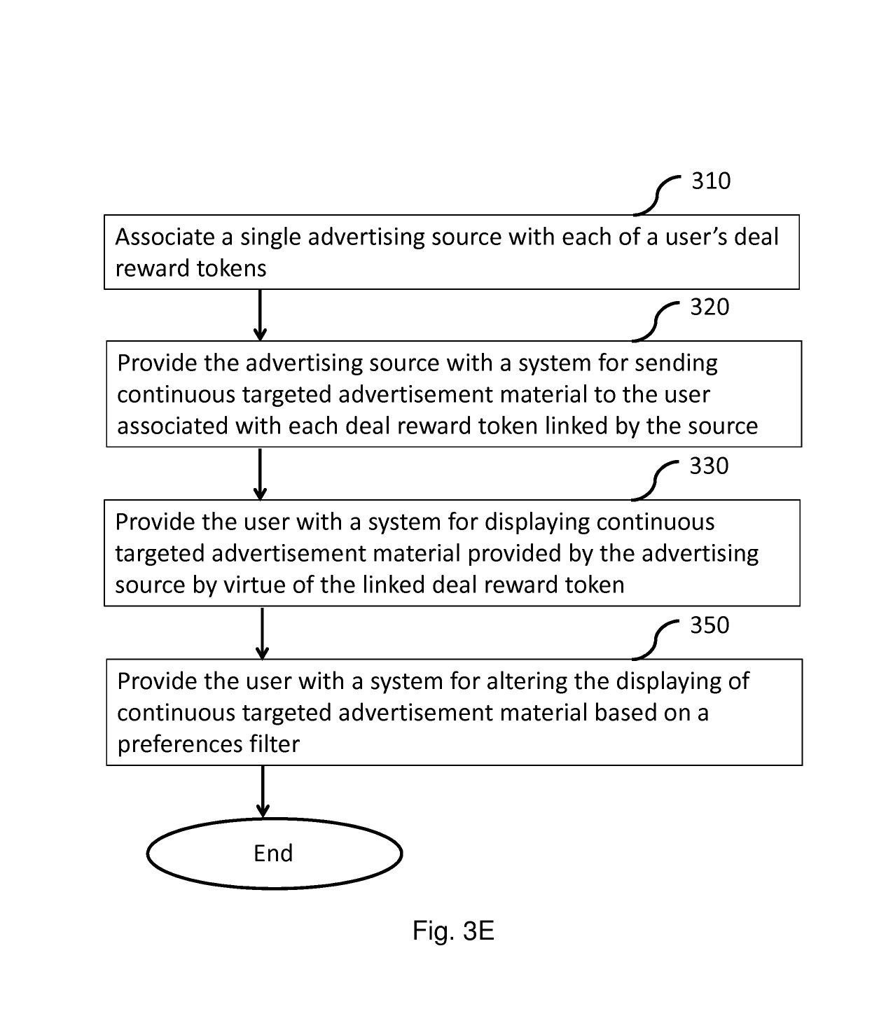

FIGS. 3A, 3B, 3C, 3D, and 3E are flow diagrams illustrating different scenarios in which a user is provided with continuous targeted advertisement material based on the advertising sources associated with the user's deal reward tokens. It should be noted that any process descriptions or blocks in flow diagrams should be understood as representing steps for implementing specific logical functions in the process. Furthermore, alternative implementations are included within the scope of the present invention in which functions may be executed out of order from that shown or discussed, including substantially concurrently or in reverse order, depending on the functionality involved, as would be understood by those reasonably skilled in the art of the present invention.

As shown in FIG. 3A, a single advertising source is associated with each of a user's deal reward tokens in block 310. In block 320, an advertising source is provided with a system for sending continuous targeted advertisement material to the user associated with each deal reward token linked to the advertising source. In block 330, a user is provided a system for displaying continuous targeted advertisement material provided by the advertising source. In one embodiment, a restaurant chain is associated with one of a user's deal reward tokens. The manufacturer provides to the user a continuous coupon for 10% off a dinner at one of the restaurant chain's locations through the system. The user sees this coupon displayed through their system.

As shown in FIG. 3B, multiple advertising sources are associated with each of a user's deal reward tokens in block 315. In block 320, an advertising source is provided with a system for sending continuous targeted advertisement material to the user associated with each deal reward token linked to the advertising source. In block 330, a user is provided a system for displaying continuous targeted advertisement material provided by the advertising source. In one embodiment, a restaurant chain and a taxi service are associated with one of a user's deal reward tokens. The manufacturer provides to the user a continuous coupon for 10% off a dinner at one of the restaurant chain's locations through the system. The taxi service provides a specialized toll-free telephone number for the user to call that allows him to bypass the public queuing system and access the taxi dispatch system more easily. The user sees this coupon and the specialized toll-free telephone number displayed through their system.

As shown in FIG. 3C, a single advertising source is associated with each of a user's deal reward tokens in block 310. In block 320, an advertising source is provided with a system for sending continuous targeted advertisement material to the user associated with each deal reward token linked to the advertising source. In block 330, a user is provided a system for displaying continuous targeted advertisement material provided by the advertising source. In block 340, a user is provided a system to communicate electronically with the advertising source associated with each of a user's deal reward tokens. In one embodiment, a restaurant chain is associated with one of a user's deal reward tokens. The manufacturer provides to the user a continuous coupon for 10% off a dinner at one of the restaurant chain's locations through the system. The user sees this coupon displayed through their system. The user is also able to communicate electronically with the advertising source in methods that may include but are not limited to electronic mail, instant messaging, facsimile, telephony, and video conferencing.

As shown in FIG. 3D, a single advertising source is associated with each of a user's deal reward tokens in block 310. In block 320, an advertising source is provided with a system for sending continuous targeted advertisement material to the user associated with each deal reward token linked to the advertising source. In block 330, a user is provided a system for displaying continuous targeted advertisement material provided by the advertising source. In block 345, a user is provided a system for altering the sending of continuous targeted advertisement material by an advertising source based on a preferences filter. In one embodiment, a restaurant chain is associated with one of a user's deal reward tokens. The manufacturer provides to the user a continuous coupon for 10% off a dinner at one of the restaurant chain's locations through the system. The user sees this coupon displayed through their system but then uses their preferences filter to change their sending preferences to no longer receive any 10% coupons, causing the coupon to no longer be sent by the advertising source to the user's system.

As shown in FIG. 3E, a single advertising source is associated with each of a user's deal reward tokens in block 310. In block 320, an advertising source is provided with a system for sending continuous targeted advertisement material to the user associated with each deal reward token linked to the advertising source. In block 330, a user is provided a system for sending continuous targeted advertisement material provided by the advertising source. In block 350, a user is provided a system for altering the sending of continuous targeted advertisement material by an advertising source based on a preferences filter. In one embodiment, a restaurant chain is associated with one of a user's deal reward tokens. The manufacturer provides to the user a continuous coupon for 10% off a dinner at one of the restaurant chain's locations through the system. The user sees this coupon displayed through their system but then uses their preferences filter to change their display preferences, resulting in the coupon disappearing from view in the user's system even though the 10% coupon is still being sent by the advertising source.

It should be noted that the above-described embodiments of the present invention are merely possible examples of implementations set forth for a clear understanding of the principles of the invention. Many variations and modifications may be made to the above-described embodiments of the invention without departing substantially from the spirit and principles of the invention. All such variations and modifications are intended to be included within the scope of this disclosure and the present invention and protected by the following claims.

The invention claimed is:

1. A computer implemented system and method for providing a prize to a user based on that user's ownership of a specified collection of deal reward tokens comprising the steps of:
Giving a single deal reward token taken from at least one available set of deal reward tokens to a user based on the mapping of that token to a deal reward provided to a user;
Requiring a user to own a discrete set of at least one reward token linked to a given prize in order to be eligible to obtain a primary prize;
Giving a user owning a discrete set of at least one reward token linked to a primary prize the option to own that primary prize in exchange for the linked deal reward token;
Giving a user owning a discrete set of at least one deal reward token linked to a primary prize that primary prize if they choose to own it in exchange for the linked deal reward token;
Providing a user a system for conducting transactions related to their deal reward tokens and primary prizes with at least one other user in an online social environment.

2. The method of claim 1, wherein the step of providing the user a system for conducting transactions is further refined to providing the user a system for conducting transactions related to their deal reward tokens and primary prizes with at least one other user in an online social environment that allows a user to electronically communicate directly with other online users in a social environment.

3. The method of claim 1, wherein the step of providing the user a system for conducting transactions is further refined to providing the user a system for conducting transactions related to their deal reward tokens and primary prizes with at least one other user in an online social environment that allows a user to exchange one or more deal reward tokens with another user for an item of value.

4. The method of claim 1, wherein the step of providing the user a system for conducting transactions is further refined to providing the user a system for conducting transactions related to their deal reward tokens and primary prizes with at least one other user in an online social environment that allows a user to engage in associated online activities related to an online user's deal reward token.

5. The method of claim 1, wherein the step of providing the user a system for conducting transactions is further refined to providing the user a system for conducting transactions related to their deal reward tokens and primary prizes with at least one other user in an online social environment that allows a user to redeem one or more deal reward tokens for a secondary prize.

6. The method of claim 1, further comprising the step of providing a deal reward to a user.

7. The method of claim 1, further comprising the step of collecting the attribute data of an identified user at an online location using an online identification instrument.

8. The method of claim 7, further comprising the step of using a preferences filter to determine what attribute data of an identified user is collected.

9. The method of claim 7, further comprising the step of providing a deal reward to a user based on a user's collected attribute data.

10. The method of claim 9, further comprising the step of providing a deal reward to a user based on the use of a preferences filter to determine what attribute data of an identified user is collected.

11. A computer implemented method for providing a persistent link between an advertising source and a user in order to provide a continuous online advertising channel, comprising the steps of:
Associating a single advertising source with each of a user's deal reward tokens;
Providing the advertising source with a system for sending continuous targeted advertisement material to the user associated with each deal reward token linked to the source;
Providing the user with a system for displaying continuous targeted advertisement material provided by the advertising source.

12. The method of claim 11, wherein the step of associating a single advertising source is further refined to include associating more than one advertising source with each of a user's deal reward tokens.

13. The method of claim 11, further comprising the step of providing the user an online technical means to communicate electronically with the advertising source associated with each of a user's deal reward tokens.

14. The method of claim 11, further comprising the step of providing the user an online technical means of altering the sending of continuous targeted advertisement material by an advertising source based on a preferences filter.

15. The method of claim 11, further comprising the step of providing the user an online technical means of altering the displaying of continuous targeted advertisement material based on a preferences filter.
